(19) United States
(12) Patent Application Publication
(10) Pub. No.: US 2025/0026129 A1
(43) Pub. Date: Jan. 23, 2025

(54) PRINT MATERIAL RESERVOIR, PRINTHEAD ASSEMBLY AND INKJET PRINTER

(71) Applicant: Kateeva, Inc., Newark, CA (US)

(72) Inventors: Geoffrey Kenneth Love, Lafayette, CA (US); Alexander Sou-Kang Ko, Santa Clara, CA (US)

(73) Assignee: Kateeva, Inc., Newark, CA (US)

(21) Appl. No.: 18/716,463

(22) PCT Filed: Nov. 25, 2022
(86) PCT No.: PCT/US2022/080465

§ 371 Date: Jun. 4, 2024

Related U.S. Application Data
(60) Provisional application No. 63/265,245, filed on Dec. 10, 2021.

(51) Int. Cl. B41J 2/175; B41J 2/18

(52) U.S. Cl. CPC B41J 2/17566; B41J 2/17513; B41J 2/17553; B41J 2/17556; B41J 2/18; B41J 2002/17516

(57) ABSTRACT

A reservoir for a print material in a printer includes an inner vessel to contain the print material, a housing in which the inner vessel is received, a weight sensor, a source tube, a drain tube and a pressure control port. The weight sensor is disposed between a bottom portion of the inner vessel and a bottom portion of the housing, and supporting the inner vessel. The source tube extends through the housing to supply the print material to the inner vessel. The drain tube extends through the housing to discharge the print material from the inner vessel. The pressure control port extends through the housing to supply a pressurized gas for pressurizing an interior of the housing to cause the print material in the inner vessel to be discharged through the drain tube.

### CROSS-REFERENCE TO RELATED MATTERS

This application claims priority from U.S. Provisional Application No. 63/265,245, filed Dec. 10, 2021, which is hereby incorporated by reference in its entirety.

### BACKGROUND

Industrial inkjet printers are used to apply materials to large substrates to form devices of all kinds. The substrates can be rigid or flexible, thick or thin, and can be made of an array of materials. The most common types of substrates used in this way are substrates made of various types of glass, which are processed to make electronic displays such as televisions and displays for smart phones.

Such displays are typically made on a large sheet of glass, with many devices mapped out on the sheet. Making multiple devices in one processing pass achieves economy of scale, reducing the unit price of the individual devices. There is a continuing need to enlarge the processing format for display manufacture, which also applies to manufacture of other electronic devices on other substrates.

For display devices, in particular, the promise of increasing economy of scale is challenged by uniformity problems that mount with increasing scale. Manufacturing processes for display devices often result in visible artifacts, such as lines and patterns, in the device that render the device unusable. These problems have been largely solved in current commercial printers, but increasing scale always invites new uniformity problems.

Naturally, as larger substrates with larger print areas are processed, printing takes longer. There is also the parallel need to speed up manufacture of single substrates.

Additionally, there is always a trend in display devices toward higher resolution complicating the drive toward larger format manufacturing. Reducing the size of drops printed on a substrate always comes with the possibility of new uniformity problems. Thus, there is a need to increase the scale and speed of commercial inkjet printing, while also increasing the resolution of commercial inkjet printing, all while maintaining uniform device construction without visible defects.

### SUMMARY

In at least one embodiment, a reservoir for a print material in a printer comprises an inner vessel to contain the print material, a housing in which the inner vessel is received, a weight sensor, a source tube, a drain tube and a pressure control port. The weight sensor is disposed between a bottom portion of the inner vessel and a bottom portion of the housing, and supports the inner vessel. The source tube extends through the housing to supply the print material to the inner vessel. The drain tube extends through the housing to discharge the print material from the inner vessel. The pressure control port extends through the housing to supply a pressurized gas for pressurizing an interior of the housing to cause the print material in the inner vessel to be discharged through the drain tube.

In at least one embodiment, a printhead assembly for an inkjet printer comprises a case, at least one printhead supported on the case and comprising a plurality of nozzles from which a print material is to be ejected, and a fluid recirculation circuit at least partially supported on the case to recirculate the print material to and from the at least one printhead. The fluid recirculation circuit comprises at least one reservoir to contain an amount of the print material being recirculated through the fluid recirculation circuit. The at least one reservoir is supported on the case, and comprises a sensor to detect a weight of the amount of the print material contained in the reservoir.

In at least one embodiment, an inkjet printer comprises a substrate support, a printhead assembly support, and a printhead assembly coupled to the printhead assembly support and moveable along the printhead assembly support in a first direction. The printhead assembly comprises at least one printhead comprising a plurality of nozzles from which a print material is to be ejected toward the substrate support, and a reservoir coupled to the at least one printhead to supply the print material to the at least one printhead or to receive the print material returned from the at least one printhead. The reservoir comprises a load cell having a beam deformable under a weight of the print material contained in the reservoir. The beam extends along a second direction transverse to the first direction.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top, perspective view of an inkjet printer according to one embodiment.

FIG. 2 is a bottom, perspective view of a printhead assembly according to one embodiment.

FIG. 3A is a schematic diagram of a fluid recirculation circuit for recirculating a print material in a printhead assembly, according to one embodiment.

FIG. 3B is a schematic diagram of a pressure control circuit for a print material reservoir in a printhead assembly, according to one embodiment.

FIGS. 4A-4B are schematic diagrams of an inner vessel in a print material reservoir, according to one embodiment.

FIG. 5A is a top-front-right, perspective view of a print material reservoir, according to one embodiment.

FIG. 5B is a top-left-front, perspective view of the print material reservoir in FIG. 5A, with an upper part of the print material reservoir being removed.

FIG. 5C is an enlarged perspective view of the upper part of the print material reservoir in FIG. 5A, in a cross-section along an X-Z plane as indicated by a cross-section line II-II in FIG. 5B.

FIG. 5D is a perspective view of the print material reservoir in FIG. 5A, in a cross-section along a Y-Z plane as indicated by a cross-section line I-I in FIG. 5A.

FIG. 5E is an enlarged perspective view of a lower part of the print material reservoir in FIG. 5D.

FIG. 5F is a side cross-sectional view of the print material reservoir in FIG. 5D.

FIG. 5G is an enlarged perspective view of the lower part of the print material reservoir in FIG. 5F.

FIG. 5H is an enlarged perspective view of the lower part of the print material reservoir in FIG. 5A, in a cross-section along an X-Z plane.

FIG. 5I is an enlarged bottom-front-right, perspective view of the bottom portion of the print material reservoir in FIG. 5A.

FIG. 5J is an enlarged, top perspective view of a bottom portion of the print material reservoir in FIG. 5A.

### DETAILED DESCRIPTION

The following disclosure provides many different embodiments, or examples, for implementing different features of the provided subject matter. Specific examples of components, values, operations, materials, arrangements, etc., are described below to simplify the present disclosure. These are, of course, merely examples and are not intended to be limiting. Other components, values, operations, materials, arrangements, etc., are contemplated. For example, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Inkjet printers described herein have a reservoir for a print material (also referred to herein as “print material reservoir”), the reservoir comprising a sensor to detect a weight or mass of the print material contained in the reservoir. Based on the detected weight or mass of the print material contained in the reservoir and a known geometry of the reservoir, it is possible to determine, e.g., using a controller capable of computation, a level of the print material in the reservoir. Based on the determined level of the print material in the reservoir, the controller performs one or more predetermined tasks such as controlling a pressure of the print material, controlling a pressure of a pressurized gas in the reservoir, controlling automatic supply of the print material to the reservoir, generating a prompt for print material replenishment, and the like. The reservoir in accordance with some embodiments is usable in a printhead assembly in an inkjet printer, especially where a print material is recirculated through the reservoir and through at least one printhead of the printhead assembly. The inkjet printers described herein having sensors that detect weight or mass of print material in a print reservoir provide, at least, accurate detection of print material level in the reservoir, improved meniscus pressure control at the print nozzle, and calibration-free change of print materials.

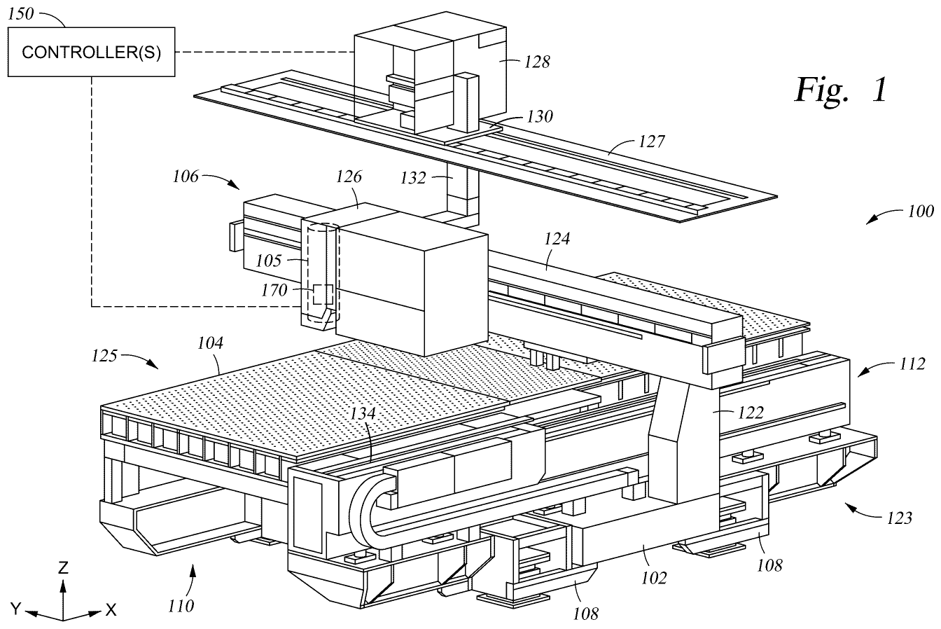

FIG. 1 is a top, perspective view of an inkjet printer 100, according to one embodiment. The inkjet printer 100 has a massive base 102 with a substrate support 104 and a print support disposed 106 on the base 102. The substrate support 104 is a flotation support that provides a gas cushion to support a substrate above the surface of the substrate support 104 without contacting the surface. The base 102, in this case, is disposed on two flotation supports 108 that float the base 102 on a gas cushion.

The substrate support 104 extends from a first end 110 of the printer 100 to a second end 112 of the printer, opposite from the first end 110. Gas for the flotation support is supplied to a plurality of openings 114 in the surface of the substrate support 104. The print support 106 comprises a first stand 122 located on a first side 123 of the substrate support 104 and a second stand (not shown) located on a second side 125 of the substrate support 104 opposite from the first side 123, such that the substrate support 104 extends between the first stand 122 and the second stand. The substrate support 104 has a long dimension, running from the first end 110 to the second end 112, which generally defines an axis referred to as the “y” axis. The first and second stands extend from the base 102 in a direction that defines an axis referred to as the “z” axis, which is perpendicular to the y axis. A substrate handler 134 is disposed alongside the substrate support 104 to move a substrate along the substrate support 104 during processing.

The print support 106 comprises a printhead assembly support 124 that rests on the first and second stands. The printhead assembly support 124 extends in a direction that defines an axis referred to as the “x” axis, which is perpendicular to the y axis and the z axis. A printhead assembly 126 is coupled to the printhead assembly support 124 by a printhead traveler (not shown) that provides movement of the printhead assembly 126 along the printhead assembly support 124, for example using a gas cushion. The printhead assembly 126 thus moves along the x axis. The print support 106 also comprises a printhead auxiliary support 127 that extends in the x-axis direction, substantially parallel to the printhead assembly support 124. The printhead auxiliary support 127 is located near the printhead assembly support 124, in this case directly above the printhead assembly support 124. The printhead auxiliary support 127 can be located at a similar elevation as the print support 106, but displaced in the y direction. A printhead supply assembly 128 is coupled to the printhead auxiliary support 127 to isolate vibration and other movements from the printhead assembly 126. The printhead supply assembly 128 comprises a printhead supply traveler 130 that couples the printhead supply assembly 128 to the printhead auxiliary support 127. The printhead supply assembly 128 is fluidly and electrically coupled to the printhead assembly 126 by fluid and electrical conduits to supply material, electric power, and electric signals to the printhead assembly 126. A controller, such as the controller 150, controls actuators that provide motive force to each traveler to maintain proximity of the two travelers within a tolerance of a few millimeters along the x-axis direction.

In some embodiments, the controller 150 comprises at least one hardware processor configured to control one or more operations of the inkjet printer 100 as described herein. Examples of such a processor include, but are not limited to, a microprocessor, a central processing unit (CPU), a multi-processor, a distributed processing system, an application specific integrated circuit (ASIC), or the like. In at least one embodiment, the controller 150 further comprises a non-transitory computer-readable storage device storing data and/or software to be used and/or executed by the processor. The storage device comprises an electronic, magnetic, optical, electromagnetic, infrared, and/or a semiconductor system (or apparatus or device) for storing instructions and/or data in a non-transitory manner. For example, the storage device includes a semiconductor or solid-state memory, a magnetic tape, a removable computer diskette, a random access memory (RAM), a read-only memory (ROM), a rigid magnetic disk, and/or an optical disk. As examples of optical disks, the storage device includes a compact disk-read only memory (CD-ROM), a compact disk-read/write (CD-R/W), and/or a digital video disc (DVD). In at least one embodiment, the controller 150 further comprises at least one interface circuitry for communication with external devices and/or a user. For example, the interface circuitry includes one or more of a network interface, keyboard, keypad, mouse, trackball, trackpad, cursor direction keys, card reader, communication port, display, signal light, printer and/or audio device for communicating information to/from the processor. For example, the network interface includes one or more of wireless network interfaces such as BLUETOOTH, WIFI, WIMAX, GPRS, or WCDMA; or wired network interface such as ETHERNET, USB, or IEEE-1394. In some embodiments, the controller 150 comprises several separate controllers each configured to control one or more operations or functions of the inkjet printer 100 as described herein.

The described configuration of the inkjet printer 100 is an example. Other inkjet printer configurations are within the scopes of various embodiments. For example, in at least one embodiment, the printhead auxiliary support 127, printhead supply assembly 128, conduit 132 are omitted. In at least one embodiment, for depositing a print material onto a substrate, it is sufficient that the inkjet printer 100 comprises the substrate support 104, the printhead auxiliary support 127 and the printhead assembly support 124. The substrate support 104 supports the substrate thereon while the substrate is being moved along the y-axis direction. The printhead assembly 126 is coupled to the printhead assembly support 124 and is moved along the printhead assembly support 124 in the x-axis direction, while the print material is deposited or ejected from the printhead assembly 126 onto the underlying substrate.

The printhead assembly 126 has a print material reservoir 105 that includes a sensor 170 for sensing weight or mass of print material in the reservoir 105. In one version, the sensor 170 is a load cell that provides electrical signals representing a weight of material bearing down on the load cell.

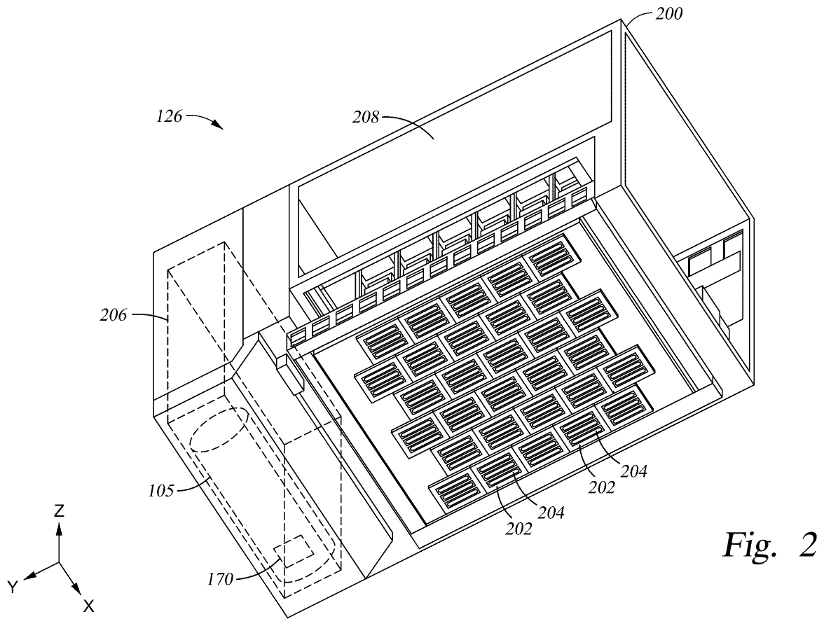

FIG. 2 is a bottom, perspective view of the printhead assembly 126, in accordance with some embodiments. In FIG. 2, the printhead assembly 126 is illustrated as being seen from below, i.e., in an upward direction from the substrate support 104.

The printhead assembly 126 comprises a housing 200, and a plurality of tiles 202 supported on the housing 200 and arranged in rows in a staggered arrangement. Each tile 202 has a plurality of printheads 204, with each printhead 204 having a plurality of nozzles. The configuration with three printheads 204 for each tile 202 in FIG. 2 is just an example. Any number of printheads per tile, e.g., two or four printheads per tile, is possible. The nozzles are too small in the view of FIG. 2 to be specifically visible. In at least one embodiment, the nozzles of each printhead 204 are arranged in an array with multiple rows and columns. In a printing operation, a print material is ejected from the nozzles of one or more printheads 204 travels toward a substrate disposed on the substrate support 104. One or more of the plurality of tiles 202 can be removed and/or rearranged to change the tile and/or printhead configurations based on printing needs. For example, where multiple print materials may need to be deposited on a substrate, using a printhead assembly with more nozzles or tiles offers more ways to deposit the multiple materials. Alternately, where fewer materials are deposited, a printhead assembly with fewer nozzles or tiles may offer all the flexibility that is needed to deposit the materials while allowing for faster processing and print plan rendering. The described tile and printhead configuration is an example. Other configurations are within the scopes of various embodiments. For example, in at least one embodiment, it is sufficient that the printhead assembly 126 comprises a printhead 204.

The housing 200 further comprises a compartment 206 next to the printheads 204, and a compartment 208 above (in the z-axis direction) the printheads 204. At least a part of a fluid recirculation circuit is housed in the compartments 206, 208 to be supported by the housing 200, and to recirculate the print material, e.g., a fluid or liquid, to and from each of the printheads 204. In an example configuration, one or more reservoirs of the fluid recirculation circuit is/are housed in the compartment 206, and a delivery system with one or more manifolds, conduits, and/or valves is housed in the compartment 208 for recirculating the print material between the reservoirs and the printheads 204. Here, the print material reservoir 105 is disposed within the compartment 206 with the sensor 170 coupled to the print material reservoir 105. The print material reservoir 105 is shown here within the compartment 206, but the print material reservoir 105 can be located outside the compartment 206 in other embodiments. For example, a print material reservoir 105 with sensor 170 can be located in the same compartment as the printheads 204 or in a print supply compartment 208 separated from the printheads 204.

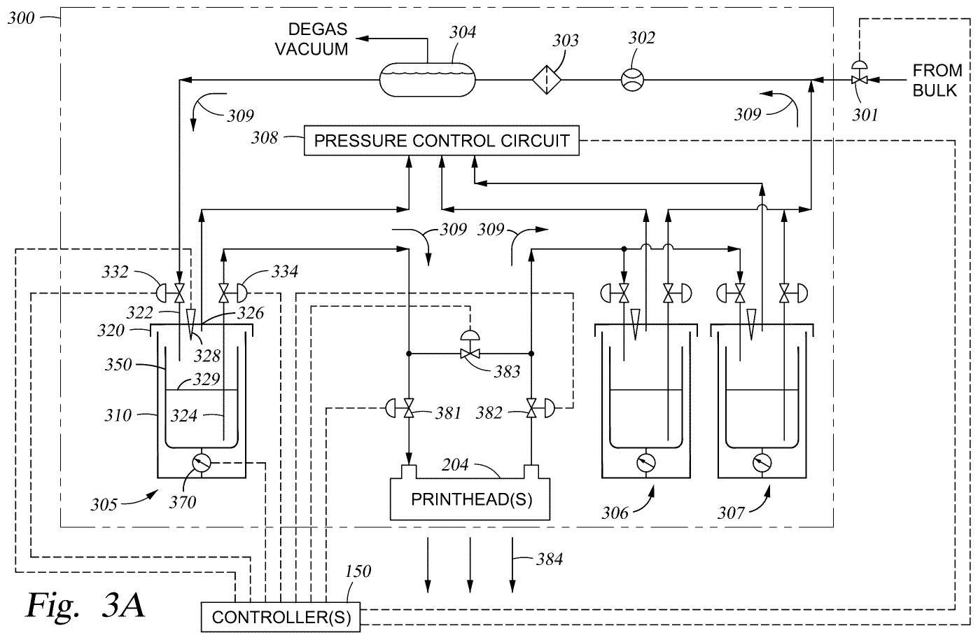

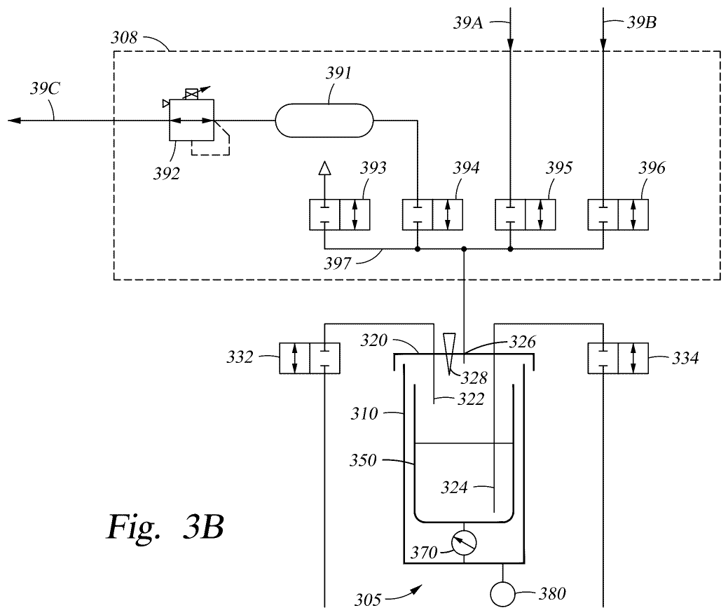

FIG. 3A is a schematic diagram of a fluid recirculation circuit 300 for recirculating a print material in the printhead assembly 126, according to one embodiment. The fluid recirculation circuit 300 is coupled to a supply valve 301 to receive a print material, e.g., a liquid frequently referred to as an “ink,” from a bulk container. In at least one embodiment, the bulk container is located outside the printhead assembly 126 and the print material is supplied from the bulk container by a pump and/or by a dip tube arrangement using a pressurized gas such as nitrogen or clean dry air. The fluid recirculation circuit 300 may use a flow meter 302, a filter 303, and a degasser 304. The fluid recirculation circuit 300 comprises a supply reservoir 305, one or more printheads 204, and return reservoirs 306, 307. A pressure control circuit 308 is coupled to the reservoirs 305-307 to supply a pressurized gas, such as nitrogen or clean dry air, to the reservoirs 305-307. The pressure control circuit 308 precisely controls pressure of the print material at the printheads 204 so that droplets of print material can be discharged from the printheads 204 to very precise specifications. Any of the reservoirs 305-307 corresponds to the print material reservoir 105 described with respect to FIGS. 1-2.

Print material flows from the supply reservoir 305 to the printheads 204 and returns to the return reservoirs 306, 307 along a circulation pathway 309. In a printing operation, the printheads 204 are controlled, e.g., by the controller 150, to eject the print material from nozzles of the printheads 204 toward a substrate on the substrate support 104, as schematically illustrated by arrows 384. In some embodiments, one of the return reservoirs 306, 307 is omitted so that in such embodiments a single return reservoir is used. The return reservoirs 306, 307 are configured similarly to the supply reservoir 305. Accordingly, a detailed description of the supply reservoir 305 is given herein, and a detailed description of the return reservoirs 306, 307 is omitted.

The supply reservoir 305 comprises an inner vessel 350 to contain the print material, a housing 310 in which the inner vessel 350 is disposed, a sensor 370 disposed between a bottom portion of the inner vessel 350 and a bottom portion of the housing 310 to detect a weight of the print material in the inner vessel 350, a source tube 322 extending through a cap 320 at a top portion of the housing 310 to supply the print material to the inner vessel 350, a drain tube 324 extending through the cap 320 the housing 310 to discharge the print material from the inner vessel 350, and a pressure control port 326 extending through the cap 320 of the housing 310 to pressurize an interior of the housing 310 to cause the print material in the inner vessel 350 to be discharged through the drain tube 324. One or more of the return reservoirs 306, 307 also has a version of the sensor 370. The sensor 370 or any similar sensor in the return reservoirs 306, 307 corresponds to the sensor 170 described with respect to FIGS. 1-2. In an alternative embodiment, the pressure control port 326 passes laterally through a side wall of the housing 310, below the cap 320, into the interior of the housing 310.

The supply reservoir 305 further comprises a level switch 328 at the cap 320 of the housing 310 to provide a signal for stopping the supply of the print material through the source tube 322 in response to a level 329 of the print material in the inner vessel 350 being at or higher than a predetermined level. In an alternative embodiment, the level switch 328 is arranged on a side wall of the housing 310, below the cap 320. The pressure control port 326 is coupled to the pressure control circuit 308. The source tube 322 is coupled to an outlet of the degasser 304 through a valve 332, and ultimately to the bulk source. Any or all of the degasser 304, the filter 303, and the flowmeter 302 may be omitted in some embodiments. The drain tube 324 is coupled to an inlet of the printhead 204 through valves 334, 381. An outlet of the printhead 204 is coupled to source tubes of the return reservoirs 306, 307 through a valve 382, and corresponding valves at the source tubes of the return reservoirs 306, 307. A bypass valve 383 may be coupled between the inlet and outlet of the printhead 204 to permit the print material to bypass the printhead 204, for example when the printhead 204 is removed or serviced or not used in a printing operation. Drain tubes of the return reservoirs 306, 307 are coupled, through corresponding valves, to an inlet of the flowmeter 302. An outlet of the flowmeter 302 is coupled to an inlet of the filter 303, and an outlet of the filter 303 is coupled to an inlet of the degasser 304 to complete a closed loop in the fluid recirculation circuit 300.

The controller 150 is coupled to the valves 301, 332, 334, 381, 382, 383, and the corresponding valves of the return reservoirs 306, 307 to turn the valves ON or OFF, and/or to control the opening of at least one of the valves. In some embodiments, the valves are controlled by electric signals and/or by pneumatic actuators. The controller 150 is coupled to the pressure control circuit 308 to control or adjust the pressure of the pressurized gas supplied to the reservoirs 305-307. In some embodiments, the pressure control circuit 308 is controlled independently from the controller 150.

The controller 150 is coupled to the level switch 328 to receive information about the level 329 of the print material in the supply reservoir 305. In some embodiments, the level switch 328 comprises a ultrasonic level switch which generates ultrasonic signals towards the surface of the print material, receives signals returned from the surface of the print material, and determines a distance from the level switch 328 to the surface of the print material based on the speed of sound and the travel time of the ultrasonic signals from the level switch 328 to the surface of the print material and back. The level 329 of the surface of the print material is then detected based on a known position of the level switch 328 and the distance between the level switch 328 and the surface of the print material. The level switch 328 sends a signal including information about the level 329 of the print material in the supply reservoir 305 to the controller 150. In response to the detected level 329 being at or greater than a predetermined level, e.g., a maximal level of the print material acceptable to be contained in the inner vessel 350, the controller 150 controls the valve 332 to be shut OFF to stop further supply of the print material into the inner vessel 350 to prevent the print material from overflowing outside the inner vessel 350. In at least one embodiment, the level switch 328 is directly coupled to the valve 332 and sends a signal to directly control the valve 332 to be shut OFF when the detected level 329 of the print material is at or higher than the maximal acceptable level, without involving the controller 150. The described ultrasonic level switch is an example. Other level switch configurations are within the scopes of various embodiments.

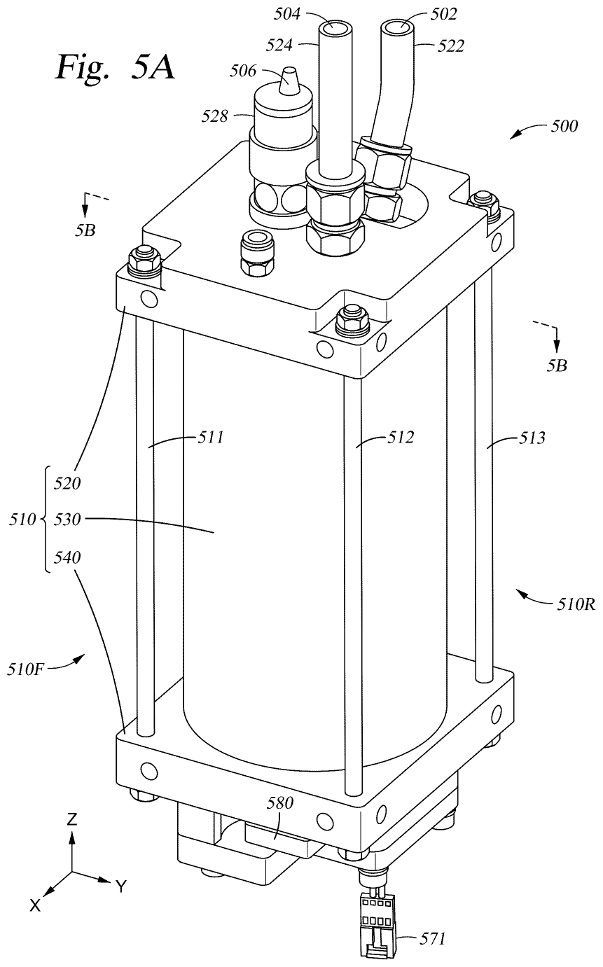

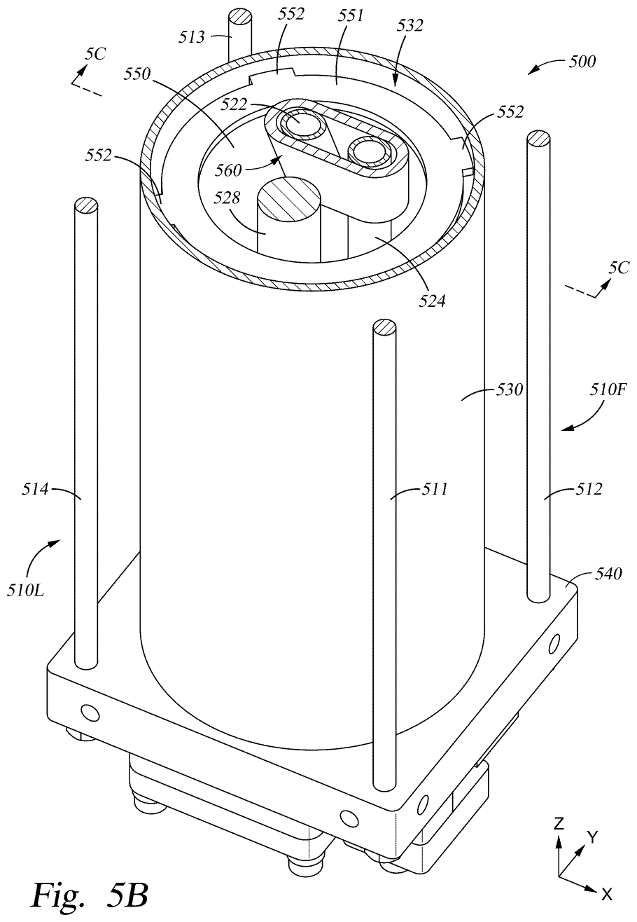

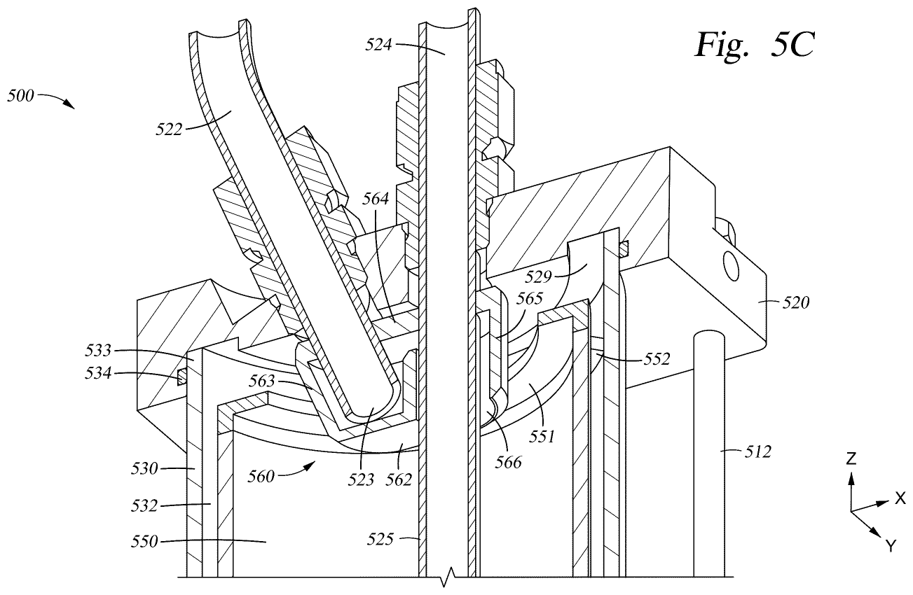

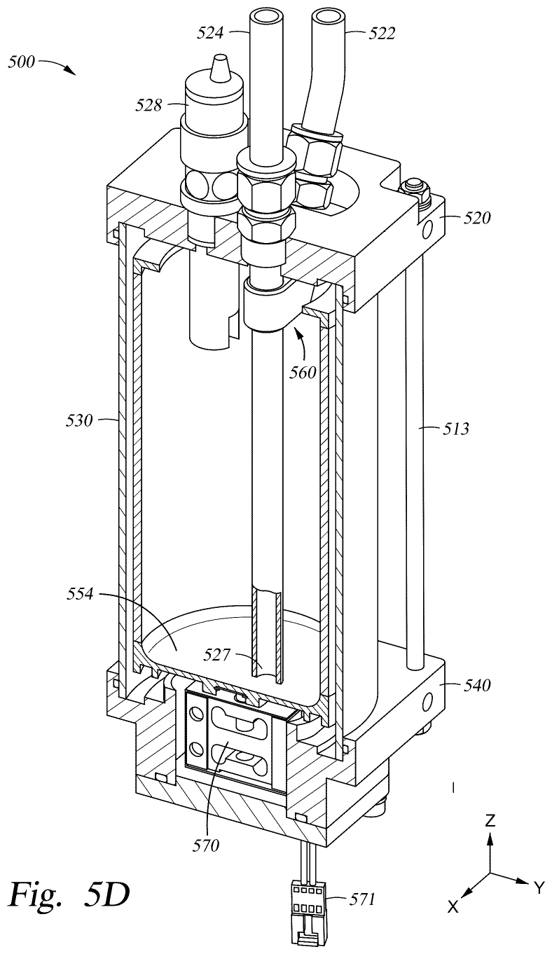

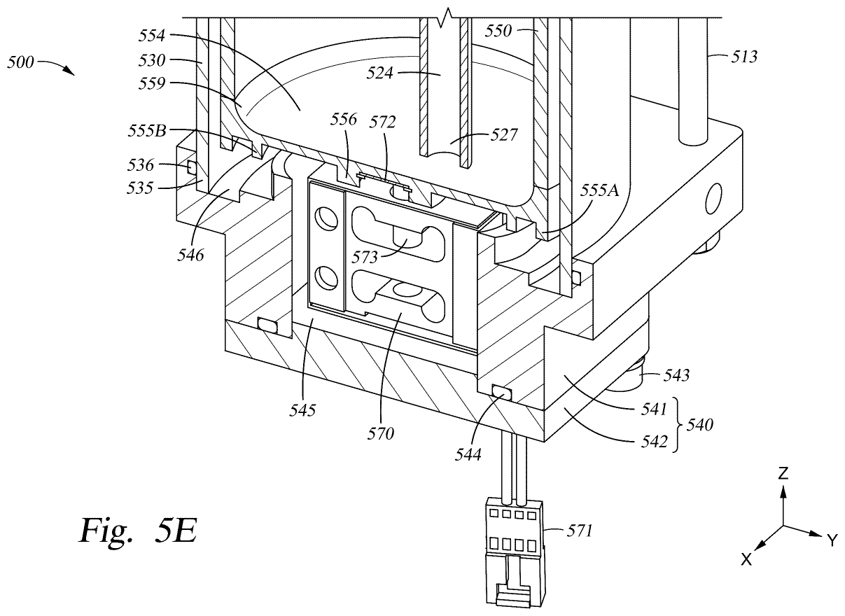

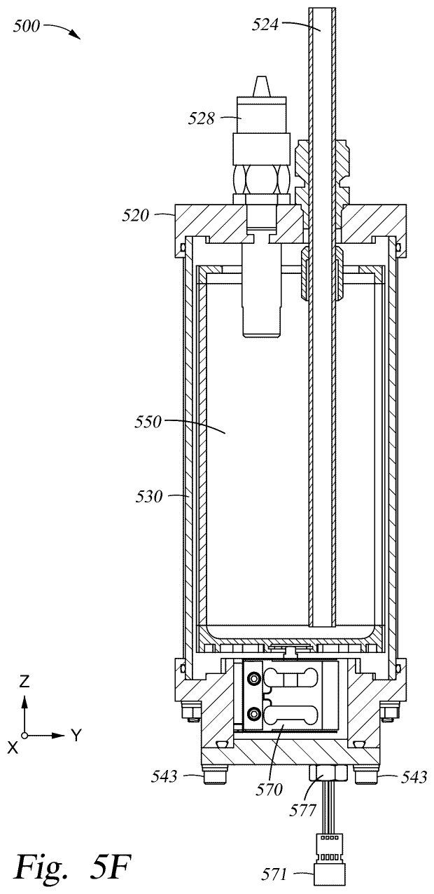

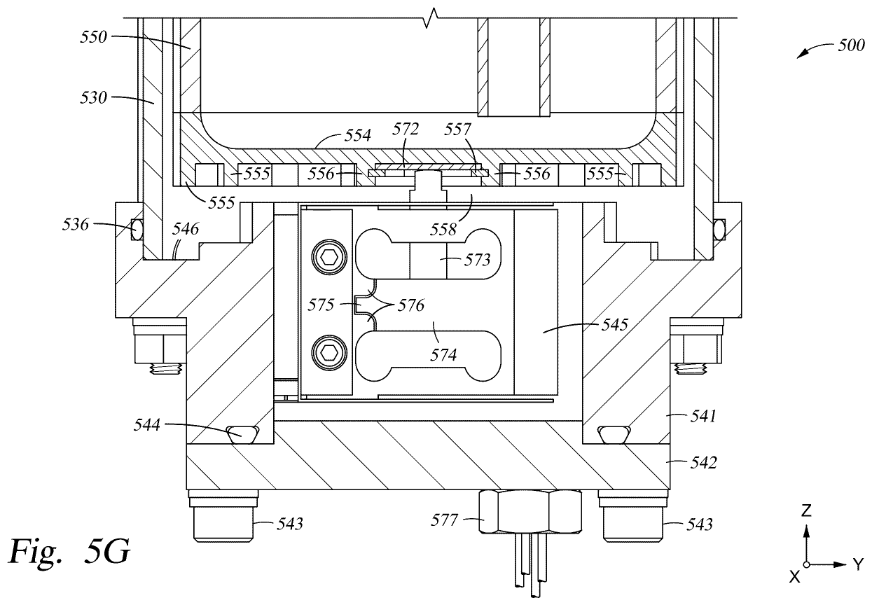

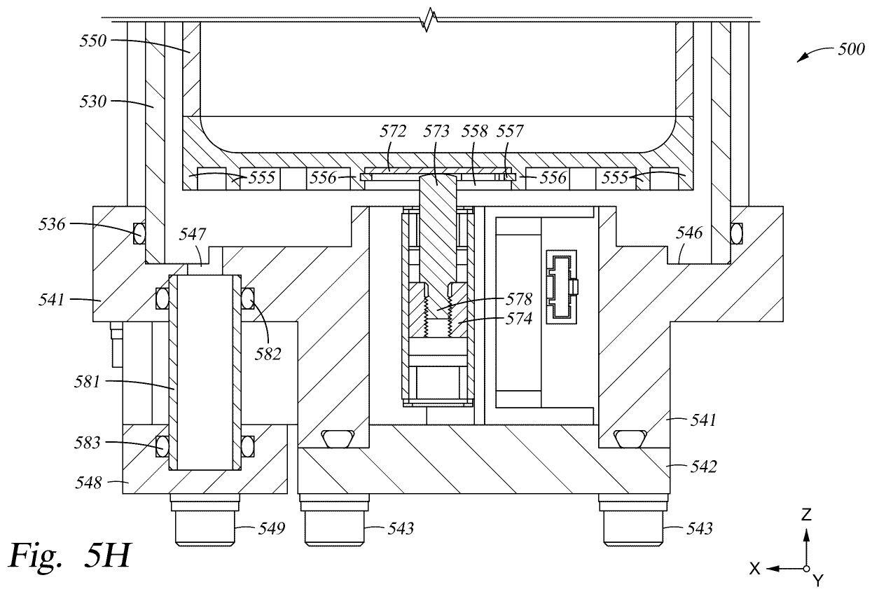

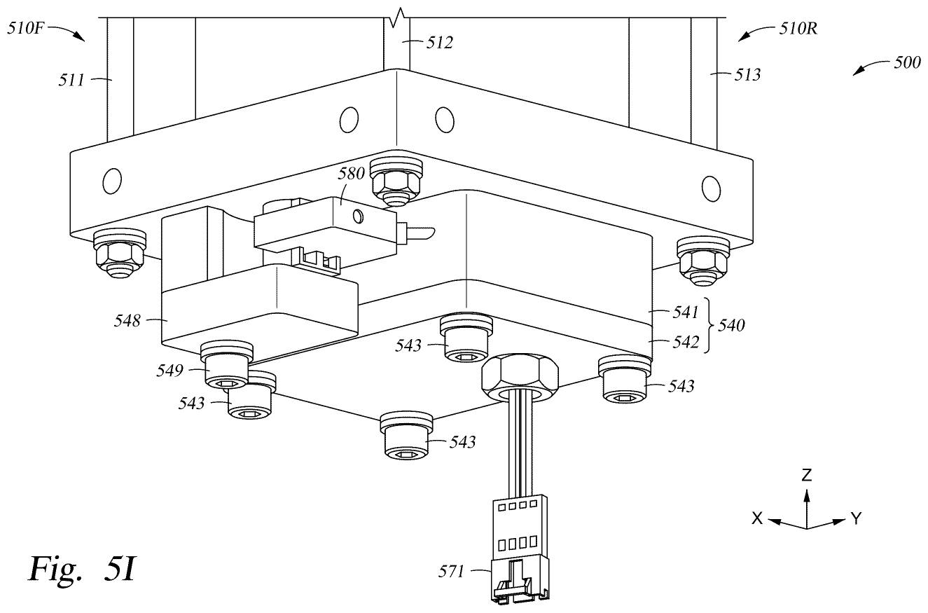

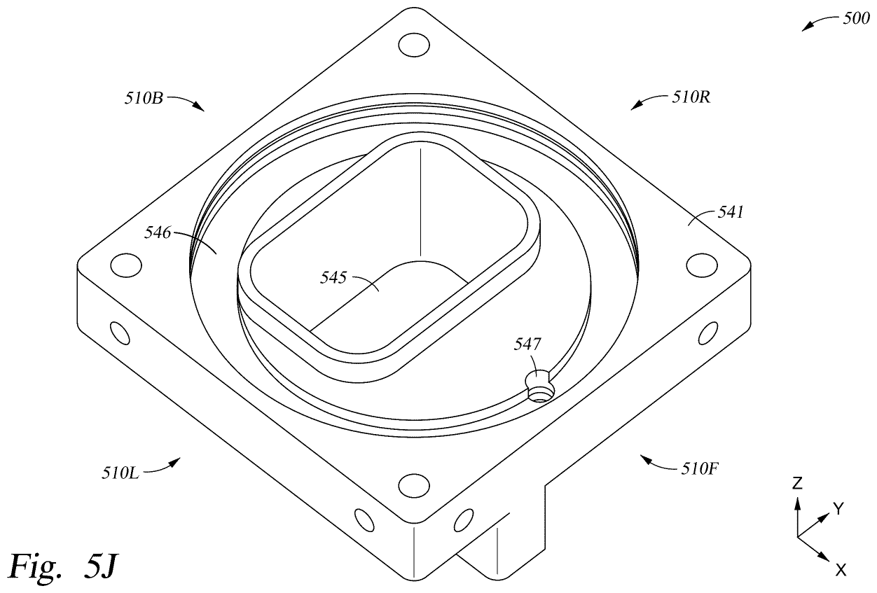

In some embodiments, the supply reservoir 305 further comprises an overflow sensor (not shown in FIG. 3A, but designated as 380 in FIG. 3B) to detect the print material overflowing or splashed outside the inner vessel 350 into the housing 310. The overflow sensor is coupled to the controller 150. When the overflow sensor detects the print material in the housing 310 but outside the inner vessel 350, the controller 150 controls the valve 332 to be shut OFF and/or generates a warning to prompt that the supply reservoir 305 is to be serviced. An example configuration of the overflow sensor is described with respect to FIGS. 5A-5J.

The source tube 322 extends through the cap 320 and has an outlet above the level 329, or surface, of the print material in the inner vessel 350. In some embodiments, the end of the source tube 322 is above the maximal acceptable level controlled by the level switch 328. As a result, there is always a gap between the end of the source tube 322 and the surface of the print material in the inner vessel 350, so the print material supplied to the inner vessel 350 through the source tube 322 is always delivered to the surface of print material in the inner vessel 350. On the other hand, the print material is discharged from near the bottom of the inner vessel 350. For this purposes, the drain tube 324, also referred to as “dip tube,” extends through the cap 320 and terminates at an end with an opening, or inlet, just above the bottom of the inner vessel 350, so the end of the drain tube 324 is almost always submerged in print material. The pressure control port 326 extends through the cap 320 and has an opening which is normally above the surface of the print material in the inner vessel 350. The pressurized gas is supplied from the pressure control circuit 308, through the pressure control port 326, into the housing 310 and pressurizes the interior of the housing 310. This pressure is applied onto the surface of the print material and causes the print material at or near the bottom of the inner vessel 350 to enter the end of the drain tube 324 and to be discharged from the inner vessel 350 via the drain tube 324 to the inlet of the printhead 204. This arrangement is referred to herein as a dip tube arrangement, and is applicable to add a print material from a bulk container to the fluid recirculation circuit 300 via the supply valve 301. In at least one embodiment, the supply valve 301 is coupled to the bulk container through the conduit 132.

The pressurized gas that causes the print material to be discharged from the supply reservoir 305 further causes the discharged print material to be supplied to the inlet of the printhead 204, and then from the outlet of the printhead 204 to the return reservoirs 306, 307 through the corresponding the source tubes. The pressurized gas is similarly supplied from the pressure control circuit 308 to interiors of the return reservoirs 306, 307 to cause the print material to be discharged from the return reservoirs 306, 307 through the corresponding drain tubes (or dip tubes) and then sequentially flow through the flowmeter 302, filter 303, degasser 304, and then back to the supply reservoir 305 through the source tube 322. As a result, the print material is recirculated in a closed loop through the fluid recirculation circuit 300. The print material moved from the return reservoirs 306, 307 to the supply reservoir 305 is metered by the flowmeter 302, filtered by the filter 303, and degassed and/or debubbled by the degasser 304 continuously during recirculation. The pressure applied by the pressurized gas to the head space of the supply and return reservoirs maintains a controlled fluid pressure at the outlet of the print nozzles (meniscus pressure), regardless of the liquid level in the reservoirs, that enables an electronic actuator of each print nozzle to eject a reproducible liquid droplet of the print material.

In some embodiments, the recirculation of the print material makes it possible to maintain homogeneity of the print material while printing proceeds or is paused. While no print material is being ejected from nozzles of one or more printheads 204 of the printhead assembly 126, the print material can be recirculated to and from the printheads 204 to maintain mixing of the print material. Further, the dip tube arrangement, in which recirculated print material is supplied to the surface of the print material contained in the inner vessel 350 whereas the print material contained in the inner vessel 350 is drained or consumed from the bottom of the inner vessel 350, makes it possible to achieve optimization of the turnover of the print material in the inner vessel 350, i.e., to achieve a controlled mixing action for print materials that require agitation.

As mentioned above, at least a part of the fluid recirculation circuit 300 is supported on the housing 200 of the printhead assembly 126, and travels together with the printheads 204 during a printing operation. In some embodiments, the entire fluid recirculation circuit 300 is arranged in at least one of the compartments 206, 208 to be fully supported by the housing 200 of the printhead assembly 126. In at least one embodiment, at least the reservoirs 305-307 are supported on the housing 200 of the printhead assembly 126, e.g., being arranged in the compartment 206. Internal structures of the printhead assembly 126 can also provide support for at least a portion of the fluid recirculation circuit 300. Such internal structures include, for example, a support tray for the print tiles 202, and a support plate which defines the floor of the compartment 208 and supports thereon the delivery system housed in the compartment 208.

In the fluid recirculation circuit 300, the supply reservoir 305 provides supply of the print material to the printheads 204 and the return reservoirs 306, 307 provide a return location for the print material from the printheads 204. In some embodiments, various valves included in the fluid recirculation circuit 300 are pneumatic valves which reduce heat from electronics that can build up in the inventory of the print material in the reservoirs 305-307. The pressure of the print material being delivered to and from the printheads 204 of the printhead assembly 126 is closely controlled by the pressure control circuit 308 which regulates the pressure of the pressurized gas applied to each of the reservoirs 305-307. In some embodiments, the pressurized gas applied to different reservoirs 305-307 have different and/or independently controlled pressures. In at least one embodiment, the pressure control circuit 308 adjusts the pressurized gas pressure within each of the reservoirs 305-307 to compensate for variations in head pressure caused by a varying weight or amount or level of the print material above the respective dip tube inlet in the reservoir. For example, when the weight or amount or level of the print material in the inner vessel 350 is high, the head pressure caused by the print material above the inlet at the end of the drain tube 324 is also high and, as a result, the pressure of the pressurized gas applied to the interior of the housing 310 is not needed to be high in order to provide the print material to the printheads 204 at a predetermined or desired pressure. When the weight or level of the print material in the inner vessel 350 is reduced due to the consumption of the print material at the printheads 204 in a printing operation, the head pressure caused by the print material above the inlet of the drain tube 324 is reduced and, as a result, the pressure of the pressurized gas applied to the interior of the housing 310 is increased to maintain the predetermined or desired pressure of the print material supplied to the printheads 204. Precise control of print material pressure at the printheads 204 allows print actuators in the printheads to produce drops of print material having consistent size.

In at least one embodiment, the controller 150 controls the pressure control circuit 308 to adjust the pressurized gas pressure applied to the interior of the housing 310 based on a sensed pressure of the print material in the dip tubes of the reservoirs 305-307 or elsewhere in the fluid recirculation circuit 300, and/or based on a sensed level of the print material within one or more of the reservoirs 305-307. When the sensed, or detected, level of the print material within one or more of the reservoirs 305-307 is lower than a predetermined threshold indicating that the print material in the fluid recirculation circuit 300 is running out, the controller 150 controls automatic replenishment of the print material, e.g., by opening the supply valve 301 and causing additional print material to be supplied via the supply valve 301 from a bulk container as described herein. Alternatively or additionally, the controller 150 generates a warning by sound, light, message, or the like, that prompts a human operator to add print material to the fluid recirculation circuit 300 and/or to the bulk container.

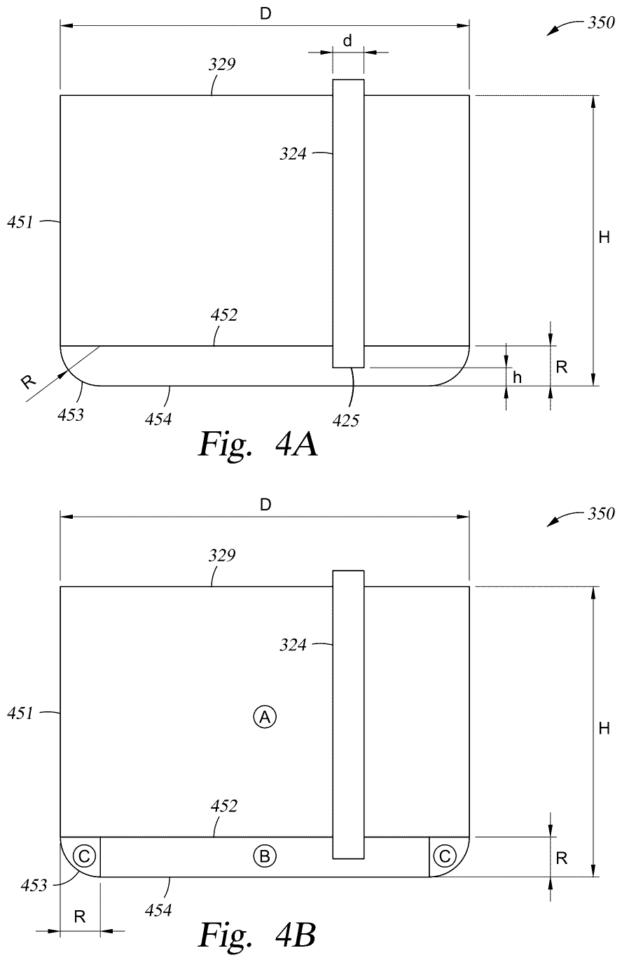

To sense or detect the level 329 of the print material in the inner vessel 350, the sensor 370 is provided to detect a weight of the inner vessel 350 and the print material contained therein. The weight of the inner vessel 350 is known in advance, e.g., from the manufacturer of the supply reservoir 305. As result, the sensor 370 actually detects the weight of the print material in the inner vessel 350. The detected weight of the print material in the inner vessel 350 is used, together with a known geometry of the inner vessel 350 and known density of the print material, to determine the level 329 of the print material, as described with respect to an example in FIGS. 4A-4B. The level 329 detected by using the sensor 370 is used, e.g., by the controller 150, to dynamically adjust the pressure of the pressurized gas applied to the housing 310 based on the detected level. In at least one embodiment, the sensor 370 comprises a load cell. Examples of load cell include, but are not limited to, strain gauge load cells, pneumatic load cells, hydraulic load cells, capacitive load cells, piezoelectric transducers, or the like. In an example configuration described with respect to FIGS. 5A-5J, a strain gauge load cell is used. Other configurations of sensors that detect weights of material contained in a vessel can be used.

In some embodiments, to achieve a high level of accuracy in the detection of the weight of the print material, the supply reservoir 305 is configured such that the weight of the inner vessel 350 and the print material contained therein is applied to the sensor 370 only, or substantially only, in a normal or vertical direction. For this purpose, the inner vessel 350 is disposed within the housing 310 with a sliding fit, such that the inner vessel 350 is slidable along a center axis thereof, while in contact with, an inner circumferential surface of the housing 310. As a result, lateral movements of the inner vessel 350 in a radial direction thereof are minimized. The sensor 370 is arranged at the center axis of the inner vessel 350, and is the only vertical support for the inner vessel 350. In this application, “vertical” refers to the direction of the gravitational force at a point on the surface of the earth. With substantially no lateral, radial direction, movements of the inner vessel 350 within the housing 310, the entire weight of the inner vessel 350 and the print material contained therein is applied in the vertical direction to the sensor 370. In addition, the contact between the side walls of the inner vessel 350 and the housing 310 is substantially frictionless, or with a lowest possible level of friction, so that friction produces no vertical force on the inner vessel 350. As a result, the weight detection by the sensor 370 is performed with high accuracy. An example configuration for achieving a negligible level of friction between the inner vessel 350 and housing 310 is described with respect to FIGS. 5A-5J.

FIG. 3B is a schematic diagram of the pressure control circuit 308 for a print material reservoir in the printhead assembly 126, in accordance with some embodiments. The pressure control circuit 308 comprises a vessel 391, a variable control valve 392 coupled to the vessel 391, and at least one control valve, for example, a plurality of control valves 393-396 coupled to a manifold 397. The manifold 397 is coupled to a first pressurized gas source 39A via the control valve 395, and a second pressurized gas source 39B via the control valve 396. The multiple pressurized gas sources differ in one or more of pressure, gas type, gas flow, capacity, or the like, and provide additional pressure control options for the pressure control circuit 308. In at least one embodiment, the control valve 396 and the corresponding second pressurized gas source are omitted. In at least one embodiment, more than two pressurized gas sources are coupled to the manifold 397. The variable control valve 392 is coupled to a third pressure source 39C which, in at least one embodiment, is a vacuum source.

At least a part of the pressure control circuit 308 is supported on the housing 200 of the printhead assembly 126. In at least one embodiment, the entire pressure control circuit 308 is supported on the housing 200. The pressurized gas sources and/or vacuum source are provided outside the printhead assembly 126 and the pressurized gas and/or vacuum is/are supplied from the pressurized gas sources and/or vacuum source to the pressure control circuit 308 through, for example, the conduit 132 (FIG. 1).

The control valves 393-396 are ON/OFF valves, and are coupled to and controlled by the controller 150. The controller 150 executes control to turn ON one of the control valves 393-396 at a given time. The pressure control port 326 of the reservoir 305 is coupled to the manifold 397 to be exposed to one of a plurality of pressures, such as vent (via control valve 393), adjustable/controlled vacuum (via control valve 394), a first pressure (via control valve 395), and a second, different pressure (via control valve 396). The control valve 393 is normally closed, and is opened to purge (or vent) the pressurized gas from the reservoir 305, for example, when the printhead assembly 126 is serviced. The variable control valve 392 is adjusted, e.g., by the controller 150, to precisely control the pressure (vacuum) in the reservoir 391, for making small changes to compensate for fluid density and level. When the control valve 394 is turned ON by the controller 150, the reservoir 305 is exposed to the adjustable/controlled vacuum in the vessel 391 to control gas pressure in the reservoir 305 over a wide range, which can be useful for controlling ejection of print materials having a wide variety of densities. For example, if a print material has a low density, a small change of the print material level in any print material reservoir can be compensated by a small change in gas pressure. If the control valve 394 is too big to control the small gas pressure change precisely, gas back-pressure can be reduced to allow the control valve 394 to function. If a print material has a high density, a small change of the print material level in any print material reservoir would be compensated by a larger change in gas pressure. Different pressurized gas sources can be used to provide one or more of the controls described above. The different pressurized gas sources can have different gas pressures. The pressure in each of the reservoirs 305-307 can be controlled independently. For this purpose, the pressure control ports of the reservoirs 305-307 are coupled to different sections of the manifold 397, or to different manifolds, which have different pressure options. The controller 150 is coupled to the valves 392-396 to control the opening and/or closing of the valves 393-396, and/or to adjust the variable control valve 392. The described configuration of the pressure control circuit 308 in FIG. 3B is an example. Other pressure control circuit configurations can be used.

FIGS. 4A-4B are schematic diagrams of two embodiments of the inner vessel 350. For simplicity, the part of the inner vessel 350 above the surface or level 329 of the print material is omitted. Likewise, the source tube 322, pressure control port 326, and level switch 328, which are normally above the surface 329 of the print material, are also omitted.

In the example configuration in FIG. 4A, the inner vessel 350 has an upper cylindrical portion with a straight side wall 451. The upper cylindrical portion ends at a location 452 where the straight side wall 451 transitions into a radiused corner portion 453 which, in turn, transitions to a bottom wall 454 of the inner vessel 350. A height from the surface 329 of the print material to the bottom wall 454 of the inner vessel 350 is H, the inner diameter of the inner vessel 350 is D, the radius of the radiused corner portion 453 is R, a distance from an end 425 of the drain tube 324 to the bottom wall 454 of the inner vessel 350 is h, and the diameter of the drain tube 324 is d. The parameters D, R, h, and d are known from the geometry of the inner vessel 350 and the drain tube 324 in the supply reservoir 305. Parameter H is to be determined to allow control of fluid pressure at the printhead nozzles.

As illustrated in FIG. 4B, the upper cylindrical portion is indicated as portion A. The portion of the inner vessel 350 below the upper cylindrical portion A comprises a lower cylindrical portion B and an annular portion C. The upper cylindrical portion A has a diameter D and a height equal to (H-R). The lower cylindrical portion B has a diameter equal to (D-2R) and a height R. The annular portion C has a cross-section corresponding to a quarter of a circle having the radius R, an inner diameter equal to (D-2R) and an outer diameter D.

Corresponding volumes Vₐ, V_{b} and V_{c} of the portions A, B and C are represented by the following equations (1), (2) and (3), respectively:

$${V}_{a} = Π {( D / 2 )}^{2} ( H - R ) \qquad ( 1 )$$

$${V}_{b} = Π {( ( D / 2 ) - R )}^{2} ( R ) \qquad ( 2 )$$

$${V}_{c} = 2 Π [ ( ( D / 2 ) - R + ( 4 R / 3 Π ) ] Π {R}^{2} / 4 \qquad ( 3 )$$

The volume V of the print material contained in the inner vessel 350 is a sum of Vₐ, V_{b} and V_{c} minus the volume occupied by the submerged portion of the drain tube 324. The submerged portion of the drain tube 324 is a cylindrical portion which has a diameter d and a height equal to (H-h). The volume V_{d} of the submerged portion of the drain tube 324 is represented by the following equation (4):

$${V}_{d} = {Π ( d / 2 )}^{2} ( H - h ) \qquad ( 4 )$$

Thus, the volume V of the print material contained in the inner vessel 350 is represented by the following equation (5):

$$V = {V}_{a} + {V}_{b} + {V}_{c} - {V}_{d} \qquad ( 5 )$$

The volume V of the print material contained in the inner vessel 350 can also be derived from the weight W of the print material detected using the sensor 370 and the density ρᵢₙₖ of the print material, in the following equation (6):

$$V = W / {ρ}_{ink} \qquad ( 6 )$$

Combining equations (5) and (6) and collecting terms, the height H of the print material in the inner vessel 350 is represented by the following equation (7):

$$H = [ W / {ρ}_{ink} - 2 Π [ ( ( D / 2 ) - R + ( 4 R / 3 Π ) ] Π {R}^{2} / 4 + {Π ( d / 2 )}^{2} ( R - h ) - Π {( ( D / 2 ) - R )}^{2} ( R ) ] / [ Π [ {( D / 2 )}^{2} - {( d / 2 )}^{2} ] ] + R \qquad ( 7 )$$

Thus, the height H can be calculated, e.g., by the controller 150, based on the known geometry of the inner vessel 350 and the drain tube 324, the known density ρᵢₙₖ of the print material, and the weight W of the print material determined by using the sensor 370. As described herein the weight W of the print material is determined, e.g., by the controller 150, by subtracting the known weight of the inner vessel 350 from the weight detected by the sensor 370. When a new print material is to be deposited by the printhead assembly 126, it is sufficient to simply change a value of the density ρᵢₙₖ in the equation (7) to reflect the density of the new print material, and the height H of the new print material in the inner vessel 350 can be accurately determined. As a result, no sensor calibration is needed when the print material is switched and/or after the printhead assembly 126 is serviced which, in turn, saves time and labor for readying the inkjet printer and/or reduces down-time of the inkjet printer due to a print material switch or maintenance. This is an advantage over other approaches which use a different arrangement for detecting the height or level of print material in a vessel. The use of sensor 370, such as a load cell, also permits the print material level in a reservoir to be determined with higher accuracy than the other approaches. The described geometry of the inner vessel 350 and drain tube 324 is an example. Other configurations are within the scopes of various embodiments. For example, the inner vessel 350 can have a profile or cross-section with a non-circular shape, e.g., a square profile, an elliptical profile, a rectangular profile, and the like. For such embodiments, appropriate geometric relations are used to resolve fluid level from measured weight.

FIGS. 5A-5J show various views of a print material reservoir 500 according to one embodiment. The reservoir 500 can be used as any of the reservoirs 305-307 described with respect to FIG. 3A. FIG. 5A is a top-front-right, perspective view of the reservoir 500. The reservoir 500 has a top side and a bottom side along the z-axis direction. For ease of reference, other sides of the reservoir 500 between the top side and bottom side are designated as a front side 510F, a back side 510B, a left side 510L, and a right side 510R. The front side 510F and right side 510R are visible in FIG. 5A. All four sides 510F, 510B, 510L, 510R are visible in FIG. 5J.

The reservoir 500 comprises housing 510 which, in turn, comprises a top portion or cap 520, an outer tubular member 530 and a bottom portion 540. The cap 520 and the bottom portion 540 are hermetically coupled, or seal, to an upper end and a lower end of the outer tubular member 530, respectively. The reservoir 500 further comprises a source tube 522, a drain tube 524, a pressure control port 526 and a level switch 528, each of which extends through the cap 520 from outside the reservoir 500. The housing 510 is sealed where each of the source tube 522, the drain tube 524, and the pressure control port 526 protrudes through the cap 520. The source tube 522 has an end 502 and the drain tube 524 has an end 504 to be coupled to other components in a fluid recirculation circuit as described herein. The pressure control port 526 is coupled to a pressure control circuit as described herein. The level switch 528 has an electrical cable 506 coupled to a controller, such as the controller 150. In at least one embodiment, the cap 520 corresponds to the cap 320, a combination of the outer tubular member 530 and bottom portion 540 corresponds to the housing 310, the source tube 522 and drain tube 524 correspond to the source tube 322 and drain tube 324, the pressure control port 526 corresponds to pressure control port 326, and level switch 528 corresponds to level switch 328 described with respect to FIG. 3A.

The level switch 528 is arranged on a center line of the reservoir 500 along the x-axis direction. During a printing operation, a printhead assembly carrying the reservoir 500 travels along the x-axis direction while ejecting print material onto a substrate to be printed on. By arranging the level switch 528 on the center line of the reservoir 500 along the x-axis direction, i.e., along the travel direction, the level switch 528 becomes insensitive to, or is at least less likely affected by, sloshing of the print material caused by the back and forth travel of the printhead assembly.

The cap 520 and the bottom portion 540 are connected together by a plurality of rods 511-514 which are threadedly fastened with bolts (not numbered) at their respective ends to tightly and hermetically clamp the outer tubular member 530 between the cap 520 and bottom portion 540. The rods 511, 512, 513 are visible in FIG. 5A. All four rods 511-514 are visible in FIG. 5B. Also visible in FIG. 5A are an overflow sensor 580 and a connector 571 for a sensor 570 further described below.

FIG. 5B is a top-left-front, perspective view of the reservoir 500, with an upper part of the reservoir 500 being removed. Compared to FIG. 5A, the reservoir 500 in FIG. 5B is rotated anticlockwise (as seen from above) by about 90 degrees.

In FIG. 5B, the cap 520 with associated parts of the source tube 522, drain tube 524, pressure control port 526, level switch 528 are removed, to reveal an inner vessel 550 slid into the outer tubular member 530 from the top. The inner vessel 550 can be the inner vessel 350 of FIG. 3A. Also visible in FIG. 5B are interior portions of the source tube 522, drain tube 524, pressure control port 526, along with a supply terminus structure 560 disposed within the inner vessel 550 to support and position the interior portions of the source tube 422 and drain tube 524. In this case, the supply terminus structure 560 is coupled to the cap 520, but in other cases the supply terminus structure 560 could be spaced apart from the cap 520.

The inner vessel 550 comprises a top portion 551 which has a plurality of projections 552 protruding radially outwardly to contact and slide on an inner circumferential surface 532 of the outer tubular member 530. The plurality of projections 552 are arranged at equal intervals, in this case, around the circumference of the inner vessel 550. As a result, the inner vessel 550 is centered inside the outer tubular member 530, along a common center axis of the outer tubular member 530 and the inner vessel 550. In the example configuration in FIG. 5B, the inner vessel 550 comprises four projections 552, three of which are visible. The described configuration is an example. Other inner vessel configurations are within the scopes of various embodiments. In an example, the projections 552 radially protrude from a middle part, rather than from the top portion 551, of the inner vessel 550. In another example, the number of the projections 552 is other than four. In other cases, the projections 552 can be unequally distributed around the circumference of the inner vessel 550. In a further example, a single projection 552 that extends around the circumferential direction of the inner vessel 550 is provided. Projections can also be provided along the bottom of the inner vessel 550. In yet another example, one or more projections 552 is/are provided on the inner circumferential surface 532 of the outer tubular member 530, rather than on the inner vessel 550.

In the example configuration in FIG. 5B, the limited contact areas, as defined by the projections 552, between the inner vessel 550 and the outer tubular member 530 reduce friction between the inner vessel 550 and the outer tubular member 530. As described herein with respect to FIG. 3A, the reduced friction between the inner vessel 550 and the outer tubular member 530 enhances the accuracy of print material weight detection by the sensor 370.

To further reduce friction, in an example configuration, at least the projections 552 can be made from a material having a very low coefficient of friction. For example, the entire inner vessel 550, including the projections 552, can be made of fluoropolymer. The inner vessel 550 in this example is a soft molded fluoropolymer flask. Alternatively or additionally, the inner circumferential surface 532 of the outer tubular member 530 is coated with a friction reducing coating or a low friction coating. In an example, the outer tubular member 530 is a metal member, such as an anodized metal member, and has, on the inner circumferential surface 532, a coating of poly-tetrafluoroethene (PTFE). As a result, friction between the inner vessel 550 and outer tubular member 530 is negligible which permits the print material weight to be detected by the sensor 370 with enhanced accuracy.

FIG. 5C is an enlarged perspective cross-section of an upper part of the reservoir 500 taken along an X-Z plane as indicated by cross-section line II-II in FIG. 5B. The upper part of the reservoir 500 in FIG. 5C is illustrated as being seen from a low view angle, i.e., in an upward direction from the bottom portion 540.

An end 533 of the outer tubular member 530 is received in a groove 529 on an underside of the cap 520, and is hermetically sealed to a sidewall of the groove 529 by a seal 534, such as an O-ring. The source tube 522 extends obliquely through the cap 520 into the interior of the reservoir 500 at an angle relative to the drain tube 524 which is straight and oriented along the z-axis direction. An end 523 of the source tube 522 defines an outlet for the print material delivered to the reservoir 500.

The supply terminus structure 560 extends from the cap 520 through the top portion 551 of the inner vessel 550 into an interior upper region of the inner vessel 550. The supply terminus structure 560 is arranged around the end 523 of the source tube 522, and a corresponding portion of the drain tube 524, with the end 523 of the source tube 522 captured within the supply terminus structure 560. The supply terminus structure 560 comprises a weir 561, a bottom wall 562, a top wall 564, and a side wall with a first portion 563 and a second portion 565. The weir 561 is adjacent to and spaced from an outer surface 525 of the drain tube 524 by a gap. The bottom wall 562 extends, generally in a X-Y plane, from a lower end of the weir 561 away from the drain tube 524, to a distal end beyond the lower end 523 of the source tube 522. The side wall generally joins the bottom wall 562 to the top wall 564. The first portion 563 extends at an oblique angle from the distal end of the bottom wall 562 to the top wall 564. The oblique angle of the first portion 563 substantially matches the oblique angle of the source tube 522, but could be different, and the first portion 563 could even be vertical in some cases. The top wall 564 extends, generally in a X-Y plane, from an upper end of the first side wall 563 toward and beyond the drain tube 524, which extends vertically through the supply terminus structure 560 from top to bottom, and beyond. The second portion 565 extends from a distal end of the top wall 564. A through hole 566 is formed through the supply terminus structure 560, and between the weir 561 and the second portion 565. The through hole 566 has an opening in the top wall 564. The drain tube 524 extends through the supply terminus structure 560 by way of the through hole 566.

The described supply terminus structure 560 has a containment structure defined by the walls 562, 563, 564, 565 and the weir 561, with the end 523 of the source tube 522 positioned within the containment structure to supply print material into the containment structure. The lower end 523 of the source tube 522 extends obliquely with respect to the drain tube 524 and also obliquely downward toward the weir 561 which is disposed between the lower end 523 of the source tube 522 and the drain tube 524. Except for the weir 561 and the through hole 566, the supply terminus structure 560 encloses the lower end 523 of the source tube 522. As a result, the print material coming out from the outlet at the lower end 523 of the source tube 522 is guided to flow over the weir 561, and then downward along the outer surface 525 of the drain tube 524 to the surface of the print material already contained in the inner vessel 550. Thus, supply of the print material is performed in a controlled manner that prevents splashing and bubble formation. Further, the weir 561 prevents air from travelling back up the source tube 522 during low or no flow conditions.

In addition, the weir 561 provides a fixed elevation for static head pressure calculations. Specifically, as described with respect to FIG. 3A, the printhead 204 is connected between the supply reservoir 305 and the return reservoir 306 (or 307), with one connection originating at the dip tube 324 of the supply reservoir 305, and the other connection terminating at a source tube (also referred to as “return tube”) in the return reservoir 306. In an example, the return reservoir 306 has a configuration corresponding to the reservoir 500, and the source tube (return tube) of the return reservoir 306 discharges into a supply terminus structure with a weir corresponding to the weir 561. The flow of print material through the printhead 204 occurs as a result of the difference in pressure between the supply reservoir 305 and the return reservoir 306. In some cases, in the supply reservoir 305, the controller 150 is configured to constantly modify the applied pressure (from the pressure control circuit 308) to compensate for the variable depth of the print material above the inlet of the dip tube 324. In the return reservoir 306, the weir provides a constant depth reference for the source tube (return tube). As a result, in at least one embodiment, the controller 150 is not required or configured to control or provide continuous pressure adjustment in the return reservoir 306 to compensate for level changes therein.

FIG. 5D is a perspective cross-section of the print material reservoir in FIG. 5A taken along a Y-Z plane as indicated by cross-section line I-I in FIG. 5A. The reservoir 500 further comprises the sensor 570 arranged at the bottom portion 540. An end 527 of the drain tube 524 is located near a bottom 554 of the inner vessel 550.

FIG. 5E is an enlarged perspective view of a lower part of the reservoir 500 in FIG. 5D. The bottom portion 540 comprises a main body 541 and a lower cap 542 which are fastened together by fasteners 543 one of which is visible in FIG. 5E. All fasteners 543 are visible in FIG. 5I. A seal 544, such as an O-ring, is disposed between the main body 541 and lower cap 542 to hermetically seal the interior of the reservoir 500. The main body 541 has a cavity 545 to receive therein the sensor 570. The main body 541 further comprises, on an upper side thereof, an overflow moat 546 extending around and outside the circumference of the cavity 545. A lower end 535 of the outer tubular member 530 is received in the overflow moat 546, and is hermetically sealed to a sidewall of the overflow moat 546 by a seal 536, such as an O-ring. The main body 541 with the cavity 545 and overflow moat 546 is also illustrated in FIG. 5J.

The inner vessel 550 comprises a radiused corner portion 559 between the side wall and the bottom 554. In at least one embodiment, the radiused corner portion 559 corresponds to the radiused corner portion 453 described with respect to FIGS. 4A-4B. On the underside of the bottom 554, the inner vessel 550 comprises a plurality of lips 555A, 555B and a mounting feature 556 which extend downwardly toward the bottom portion 540. The outermost lip 555A is arranged to shed drips of print material overflowing or splashed outside the inner vessel 550 into the overflow moat 546 to prevent the overflown print material from fouling the sensor 570. Between the outermost lip 555A and the mounting feature 556, the underside of the bottom 554 is machined to reduce the mass of the inner vessel 550, leaving the inner lip 555B, e.g., for mechanical strength. In an example, the inner lip 555B is omitted. A load plate 572 is captured in the mounting feature 556, and a load pin 573 mechanically couples the load plate 572 to the sensor 570 to transfer the load, i.e., the weight to be detected, from the load plate 572 to the sensor 570. Further details of the load plate 572, load pin 573 and sensor 570 are described with respect to FIGS. 5G-5H. In some embodiments, the load plate 572 and load pin 573 are made of stainless steel, but the load plate 572 and load pin 573 could be made of any material suitable for transferring the weight of the inner vessel 550, and print material therein, to the sensor 570.

FIG. 5F is a side cross-sectional view of the reservoir 500 in FIG. 5D. Compared to FIG. 5D, the reservoir 500 in FIG. 5F is rotated anticlockwise by about 30 degrees. As illustrated in FIG. 5F, the connector 571 is coupled to the sensor 570 by one or more cables or cords through a sealed mounting structure 577.

FIG. 5G is an enlarged view of the lower part of the reservoir 500 in FIG. 5F. As illustrated in FIG. 5G, the load plate 572 is captured inside the mounting feature 556 which has an annular shape. A lock ring 557 having a larger diameter than the load plate 572 is press-fit inside the mounting feature 556 and over the load plate 572, to lock the load plate 572 in place. The load pin 573 has an upper end on which the load plate 572 rests, and a lower end coupled to a beam 574 of the sensor 570. The load plate 572 simply rests, or is placed on, the upper end of the load pin 573, without positive connection or attached to the upper end of the load pin 573. In some embodiments, the load pin 573 is coupled to the beam 574 by a threaded connection. Other than the load transmitting structure comprising the load plate 572 and load pin 573, the inner vessel 550 is configured to receive no other external forces in the z-axis direction so the sensor 570 will accurately record the weight of the inner vessel 550, with print material therein. The load pin 573 has a length that supports the inner vessel 550 at an elevation that defines a gap 558 between the bottom of the inner vessel 550 and the main body 541 of the bottom portion 540, the gap 558 extending around the load pin 573. Because the inner vessel 550 is centered inside the outer tubular member 530, and is slidable within the outer tubular member 530 substantially without friction, the load or weight of the inner vessel 550 and the print material contained therein is applied to the load plate 572, the load pin 573 and then the beam 574 only, or substantially only, in the vertical or z-axis direction, which improves the detection accuracy. The beam 574 is deformable, e.g., bent downward, under the weight or load applied thereto. The sensor 570 comprises strain gauges (not shown) and associated circuitry which detect and convert the mechanical deformation of the beam 574 into an electric signal that represents the detected weight. The electric signal is output through the connector 571 to the controller 150, which converts the electric signal to detected weight data, which in turn is used to determine the level of the print material in the inner vessel 550 and to control the level, as described above.

The beam 574 has an end 575 received between, and normally spaced from, projections 576. During normal weight detection operation, even when the beam 574 is bent, the end 575 remains spaced from the projections 576. When the load applied to the beam 574 is excessive, e.g., during installation of the sensor 570 in the reservoir 500, the end 575 rests on one of the projections 576. The projections 576 provide inherent overload protection and prevent the sensor 570 from damage.

A further feature of the sensor 570 is that the beam 574 extends along the y-axis direction which is transverse to the travel direction, i.e., the x-axis direction, of the printhead assembly carrying the reservoir 500. In this arrangement, deformations of the beam 574 occur in a Y-Z plane perpendicular to the travel direction. As a result, movements of the printhead assembly and the reservoir 500 during a printing operation have no, or minimal, impact on weight measurements by the sensor 570. The described orientation of the sensor 570 further minimizes effects of jerk and/or acceleration of the printhead assembly travel on the weight measurements by the sensor 570. In the described example configuration, the sensor 570 is a load cell. In at least one embodiment, the load cell is made of a metal, e.g., aluminum or stainless steel. Other types of weight detecting sensors are within the scopes of various embodiments.

FIG. 5H is an enlarged perspective view of the lower part of the reservoir 500, in a cross-section along an X-Z plane. In other words, the cross-section plane in FIG. 5H is perpendicular to the cross-section plane in FIG. 5G. The upper end of the load pin 573, on which the load plate 572 rests, is convex. In this case, the convex end of the load pin 573 has a smooth spherical curvature, but in other cases the upper end could have a more pointed, conical configuration. In at least one embodiment, there is no attachment or fixing between the load plate 572 and the curved, upper end of the load pin 573. The lower end of the load pin 573 can have a thread 578 to engage with a threaded hole in the beam 574 of the sensor 570.

A through hole 547 is formed at a location in the overflow moat 546, and extends through the main body 541 at that location. Another view of the through hole 547, overflow moat 546 and cavity 545 is illustrated in FIG. 5J. A tube 581 of the overflow sensor 580 is arranged below and aligned with the through hole 547. The tube 581 is pressed, by fastening a fastener 549, between the main body 541 and a cap piece 548. The cap piece 548 is separate from the lower cap 542. An upper end of the tube 581 is sealed against the main body 541 by a first seal 582, such as an O-ring. A lower end of the tube 581 is sealed against the cap piece 548 by a second seal 583, such as another O-ring. The overflow sensor 580 (described with respect to FIG. 5I) is a tube-mounted optical overflow sensor that is mounted to the main body 541 by the tube 581.

When an overflow of the print material occurs, due for example to malfunction of the level switch 528 or splashing of the print material, an amount of the overflown print material is collected in the overflow moat 546. The collected print material flows through the through hole 547 into the tube 581 where it is detected by the overflow sensor 580. The detected overflow is reported to the controller 150 which stops supply of the print material into the inner vessel 550 and/or generates a warning to prompt an operator to service the reservoir 500. The print material is drained from the overflow sensor 580 by removing the cap piece 548, without the need to remove the whole reservoir 500 from a carrying printhead assembly. As a result, fluid overflow detection and protection of the sensor 570 from contact with fluid are achievable.

FIG. 5I is an enlarged bottom-front-right, perspective view of the bottom portion of the reservoir 500. In FIG. 5I, the reservoir 500 is illustrated as being seen from below. In the view of FIG. 5I, the overflow sensor 580 is seen disposed, e.g., tube-mounted, at the bottom portion 540.

FIG. 5J is an enlarged, top perspective view of the bottom portion of the reservoir 500. Although not illustrated in FIG. 5J, the overflow sensor 580 is below and aligned with the through hole 547, and the overflow sensor 580 is located below the overflow moat 546 to detect an overflow amount of the print material drained from the overflow moat 546 into the through hole 547 and then to the tube 581. In at least one embodiment, the bottom surface of the overflow moat 546 is not horizontal, but is sloped toward the through hole 547, to promote a flow of the print material collected in the overflow moat 546 into the through hole 547 to be further detected by the overflow sensor 580. The bottom surface of the overflow moat 546 can be radially sloped and/or azimuthally sloped. In an example, a step, or shoulder, or portion of the overflow moat 546 can be sloped radially outward toward the lowest part of the moat 546.

While the foregoing is directed to embodiments of one or more inventions, other embodiments of such inventions not specifically described in the present disclosure may be devised without departing from the basic scope thereof, which is determined by the claims that follow.

1. A reservoir for a print material in a printer, the reservoir comprising:
an inner vessel to contain the print material;
a housing in which the inner vessel is disposed;
a weight sensor disposed between a bottom portion of the inner vessel and a bottom portion of the housing to support the inner vessel;
a source tube extending through the housing to supply the print material to the inner vessel;
a drain tube extending through the housing to discharge the print material from the inner vessel; and
a pressure control port extending through the housing to supply a pressurized gas for pressurizing an interior of the housing to cause the print material in the inner vessel to be discharged through the drain tube.

2. The reservoir of claim 1, wherein the inner vessel has a portion in contact with, and slidable on, an inner circumferential surface of the housing.

3. The reservoir of claim 1, wherein the weight sensor comprises a load cell.

4. The reservoir of claim 1, wherein only the weight sensor supports the weight of the inner vessel.

5. The reservoir of claim 1, further comprising:
a level switch at a top portion of the housing to provide a signal for controlling the supply of the print material through the source tube.

6. The reservoir of claim 1, further comprising:
an overflow sensor disposed at the bottom portion of the housing.

7. The reservoir of claim 1, wherein the source tube and the drain tube both extend through a top portion of the housing, and an end of the source tube is located above an end of the drain tube.

8. The reservoir of claim 7, further comprising:
a supply terminus structure extending into the inner vessel, the supply terminus structure comprising a weir to direct flow of print material from the source tube along an exterior of the drain tube.

9. The reservoir of claim 8, wherein the end of the source tube extends downward obliquely into the supply terminus structure toward the weir.

10. The reservoir of claim 1, wherein
the housing comprises an outer tubular member into which the inner vessel slidably fits and a cap that seals an upper end of the outer tubular member;
the bottom portion seals a lower end of the outer tubular member;
the source tube, drain tube and the pressure control port extend through the cap; and
an end of the source tube is above an end of the drain tube.

11. The reservoir of claim 10, wherein
the inner vessel has a plurality of projections protruding radially outwardly to contact and slide on an inner circumferential surface of the outer tubular member, and to center the inner vessel inside the outer tubular member.

12. The reservoir of claim 11, wherein
the inner vessel is a fluoropolymer flask, and
the outer tubular member is a metal member having a friction reducing coating on the inner circumferential surface.

13. The reservoir of claim 10, further comprising:
a level switch at the cap to provide a signal for stopping the supply of the print material through the source tube in response to a level of the print material in the inner vessel being at or higher than a predetermined level,
wherein the predetermined level is below the end of the source tube.

14. The reservoir of claim 13, further comprising:
a supply terminus structure coupled to the cap and comprising a weir to direct flow of print material from the source tube along an exterior of the drain tube,
wherein the end of the source tube extends downward obliquely into the supply terminus structure toward the weir.

15. The reservoir of claim 10, further comprising:
a load plate at the bottom portion of the inner vessel; and
a load pin having an upper end on which the load plate rests,
wherein
the weight sensor comprises a load cell having a deformable beam coupled to a lower end of the load pin,
the bottom portion comprises a cavity in which the load cell is disposed.

16. The reservoir of claim 15, further comprising:
an overflow sensor,
wherein
the bottom portion of the housing further comprises:
an overflow moat extending around the cavity, and
a through hole in the overflow moat, and
the overflow sensor is disposed under the overflow moat to detect an overflow amount of the print material drained from the overflow moat into the through hole.

17. The reservoir of claim 16, wherein
the overflow sensor has a tube arranged below and aligned with the through hole in the overflow moat, and
the tube is removably fastened between the bottom portion of the housing and a cap piece, with an upper end of the tube being sealed to the bottom portion of the housing and a lower end of the tube being sealed to the cap piece.

18. A printhead assembly for an inkjet printer, the printhead assembly comprising:
a housing;
at least one printhead supported by the housing, and comprising a plurality of nozzles from which a print material is to be ejected; and
a fluid recirculation circuit at least partially supported by the housing to recirculate the print material to and from the at least one printhead,
wherein
the fluid recirculation circuit comprises at least one reservoir to contain an amount of the print material being recirculated through the fluid recirculation circuit, and
the at least one reservoir is supported by the housing, and comprises a sensor to detect a weight of the print material contained in the reservoir.

19. An inkjet printer, comprising:
a substrate support;
a printhead assembly support; and
a printhead assembly coupled to the printhead assembly support and moveable along the printhead assembly support in a first direction,
wherein
the printhead assembly comprises:
at least one printhead comprising a plurality of nozzles from which a print material is to be ejected toward the substrate support, and
a reservoir coupled to the at least one printhead to supply the print material to the at least one printhead or to receive the print material returned from the at least one printhead,
the reservoir comprises a load cell having a beam deformable under a weight of the print material contained in the reservoir, and
the beam extends along a second direction transverse to the first direction.

20. The inkjet printer of claim 19, further comprising:
a controller coupled to the load cell to
receive information on the weight of the print material contained in the reservoir,
determine a level of the print material in the reservoir based on the received information, and
control at least one of (i) supply of the print material to the reservoir or (ii) a pressure of pressurized gas in the reservoir, based on the determined level of the print material in the reservoir.
